(19) United States
(12) Patent Application Publication
(10) Pub. No.: US 2025/0301516 A1
(43) Pub. Date: Sep. 25, 2025

(54) OFFLOADING ULTRA WIDE BAND CONFIGURATION TO NARROWBAND ADVERTISEMENT IN WIRELESS NETWORK

(71) Applicant: Samsung Electronics Co., Ltd., Gyeonggi-do (KR)

(72) Inventors: Ankur BANSAL, Bangalore (IN); Aniruddh Rao KABBINALE, Bangalore (IN); Karthik Srinivasa GOPALAN, Bangalore (IN)

(21) Appl. No.: 18/863,188

(22) PCT Filed: May 4, 2023
(86) PCT No.: PCT/KR2023/006135

§ 371 Date: Nov. 5, 2024

(30) Foreign Application Priority Data
May 5, 2022 (IN) 202241026227
May 2, 2023 (IN) 202241026227

(51) Int. Cl. H04W 76/11; G01S 13/08; H04W 12/03

(52) U.S. Cl. CPC H04W 76/11; G01S 13/08; H04W 12/03

(57) ABSTRACT

A method for offloading Ultra-Wideband (UWB) configuration to a Narrowband (NB) advertisement by a first electronic device (300) in a wireless network is disclosed. The method comprises generating an NB advertisement message comprising a first set of UWB parameters from a plurality of UWB parameters of a UWB configuration; sending the NB advertisement message comprising the first set of UWB parameters on an NB channel to at least one second electronic device; generating a request message comprising a second set of UWB parameters from the plurality of UWB parameters of the UWB configuration to optimize a UWB ranging setup in the wireless network; sending the request message comprising the second set of UWB parameters on the NB channel or a UWB channel to the at least one second electronic device; and receiving a response message from the at least one second electronic device.

### TECHNICAL FIELD

The present disclosure relates to wireless communication, and more particularly to a method and system for offloading Ultra Wide Band (UWB) configuration to a Narrowband (NB) advertisement message in a wireless network.

### BACKGROUND ART

In general, request/response messaging is used in UWB systems to establish UWB-ranging sessions between a first electronic device (for example, a controller and an initiator) and a second electronic device (for example, a controlee and a responder). The controller sends a request message in either in-band or Out-Of-Band (OOB) to the controlee, and the controlee reads the request message, uses the details provided in the request message to establish the UWB ranging session, and responds to the controller. The request and response message helps in the establishment of the UWB ranging session.

Conventionally, a request-response ranging setup is specific to the controller and the controlee. By using only request and response messages, the controller does not convey a schedule of UWB transmission to other controllers in the vicinity. Furthermore, the request-response messages need to be frequently exchanged every time the schedule is changed, with all the configurations as a part of request/response messages, which causes a lot of resource consumption for over-air transmissions.

Thus, it is desired to address the above mentioned disadvantages or other shortcomings or at least provide a useful alternative to optimize the request-response ranging setup.

### DISCLOSURE OF INVENTION

### Solution to Problem

The principal object of the embodiments herein is to provide a method and system for offloading a UWB configuration to an NB advertisement message in a wireless network.

Another object of the embodiments herein is to share a schedule-related information in the NB advertisement message, which helps to share a schedule of UWB transmission to other controllers and manages an NB channel.

Yet another object of the embodiments herein is to transmit the NB advertisement message before a request and response message exchange.

Yet another object of the embodiments herein is to offload certain UWB configuration parameters to the NB advertisement message from the request/response message.

Yet another object of the embodiments herein is to encrypt the NB advertisement message in a directed advertisement that is read only by the second electronic device among the plurality of electronic devices.

According to an aspect of the present disclosure, a method for offloading UltraWideband (UWB) configuration to a Narrowband (NB) advertisement by a first electronic device (300) in a wireless network is disclosed. The method may comprise generating an NB advertisement message comprising a first set of UWB parameters from a plurality of UWB parameters of a UWB configuration. The method may comprise sending the NB advertisement message comprising the first set of UWB parameters on an NB channel to at least one second electronic device. The method may comprise generating a request message comprising a second set of UWB parameters from the plurality of UWB parameters of the UWB configuration to optimize a UWB ranging setup in the wireless network. The method may comprise sending the request message comprising the second set of UWB parameters on the NB channel or a UWB channel to the at least one second electronic device. The method may comprise receiving a response message from the at least one second electronic device.

According to an aspect of the present disclosure, a first electronic device for offloading Ultra-Wideband (UWB) configuration to a Narrowband (NB) advertisement in a wireless network is disclosed. The first electronic device may comprise a memory; a communicator; and at least one processor coupled to the memory and the communicator. The at least one processor may be configured to generate an NB advertisement message comprising a first set of UWB parameters from a plurality of UWB parameters of a UWB configuration. The at least one processor may be configured to send the NB advertisement message comprising the first set of UWB parameters on a NB channel to at least one second electronic device. The at least one processor may be configured to generate a request message comprising a second set of UWB parameters from the plurality of UWB parameters of the UWB configuration to optimize a UWB ranging setup in the wireless network. The at least one processor may be configured to send the request message comprising the second set of UWB parameters on the NB channel or a UWB channel to the at least one second electronic device. The at least one processor may be configured to receive a response message from the at least one second electronic device.

According to an aspect of the present disclosure, a non-transitory computer readable storage medium storing instructions which, when executed by at least one processor (120, 140) of a first electronic device (300) in a wireless network, cause the first electronic device to perform operations is disclosed. The operations may comprise generating an NB advertisement message comprising a first set of UWB parameters from a plurality of UWB parameters of a UWB configuration. The operations may comprise sending the NB advertisement message comprising the first set of UWB parameters on an NB channel to at least one second electronic device. The operations may comprise generating a request message comprising a second set of UWB parameters from the plurality of UWB parameters of the UWB configuration to optimize a UWB ranging setup in the wireless network. The operations may comprise sending the request message comprising the second set of UWB parameters on the NB channel or a UWB channel to the at least one second electronic device. The operations may comprise receiving a response message from the at least one second electronic device

Accordingly, embodiments herein disclose a method and system for offloading a UWB configuration to an NB advertisement message in a wireless network. The method includes offloading, by a first electronic device, a first set of UWB parameters from a plurality of UWB parameters of the UWB configuration by generating the NB advertisement message comprising the first set of UWB parameters. The first set of UWB parameters comprises a ranging block structure, a schedule-related information to schedule UWB transmission between a plurality of electronic devices, a Listen Before Talk (LBT) parameter, hopping parameters, a block size, a round size, a slot size, a current index, a round hopping activation information, an NB channel hopping information and an NB channel configuration information comprising an NB channel number.

In an embodiment, the method includes sending, by the first electronic device, the NB advertisement message comprises the first set of UWB parameters on an NB channel to a second electronic device. Furthermore, the method includes generating, by the first electronic device, a request message comprising a second set of UWB parameters from the plurality of UWB parameters of the UWB configuration to optimize a UWB-ranging setup in the wireless network. Furthermore, the method includes sending, by the first electronic device, the request message comprising the second set of UWB parameters on the NB or a UWB channel to the second electronic device. Furthermore, the method includes receiving, by the first electronic device, a response message from the second electronic device.

In an embodiment, the first set of UWB parameters comprises a ranging block structure, the schedule-related information, a Listen Before Talk (LBT), hopping parameters, a block size, a round size, a slot size, a current index, a round hopping activation information, an NB channel hopping information and an NB channel configuration information comprising an NB channel number.

In an embodiment, the second set of UWB parameters comprises a ranging round usage information, a scheduled mode, a deferred mode, and a mini slot.

In an embodiment, the method includes receiving, by the second electronic device, the request message comprising the second set of UWB parameters on the NB channel or the UWB channel from the first electronic device. The method includes determining, by the second electronic device, PHY parameters and roles associated with the first electronic device. The method includes establishing, by the second electronic device, the UWB ranging session with the first electronic device based on the PHY parameters and the roles associated with the first electronic device.

In an embodiment, the method includes encrypting, by the first electronic device, a part of the NB advertisement message or a full advertisement message specific to the second electronic device. The method includes decrypting, by the first electronic device, a part of the advertisement not specific to the second electronic device.

In an embodiment, an encrypted part of the NB advertisement message in a directed advertisement is read only by the second electronic device among the plurality of electronic devices.

In an embodiment, a decrypted part of the NB advertisement message in the directed advertisement is open and intended for all the plurality of electronic devices.

Accordingly, the embodiments herein disclose a system for offloading the UWB configuration to the NB advertisement in the wireless network. The system includes the plurality of electronic devices, where the first electronic device of the plurality of electronic devices includes a memory, a processor coupled to the memory, a communicator coupled to the memory and the processor, and an advertisement management controller coupled to the memory, the processor, and the communicator. The advertisement management controller is configured to offload a first set of UWB parameters from a plurality of UWB parameters of a UWB configuration by generating an NB advertisement message comprising the first set of UWB parameters.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the invention thereof, and the embodiments herein include all such modifications.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 is a block diagram of a UWB system, according to the embodiments as disclosed herein;

FIG. 2 is a flow diagram illustrating a method for offloading a UWB configuration to an NB advertisement in a wireless network, according to the embodiments as disclosed herein;

FIG. 3 is an example illustrating usage of the NB advertisement along with a request/response message, according to the embodiments as disclosed herein; and

FIG. 4 is an example of a NB advertisement message, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, embodiments herein disclose a method and system for offloading UWB configuration to an NB advertisement message in a wireless network. The method includes offloading, by a first electronic device, a first set of UWB parameters from a plurality of UWB parameters of a UWB configuration by generating the NB advertisement message comprising the first set of UWB parameters.

Schedule-related information is sent as part of the advertisement on the NB channel. Schedule information helps other controllers in the vicinity to plan their UWB transmission so that collisions are avoided. The advertisement is unencrypted or encrypted. Also, some parts of the advertisement are unencrypted and some parts of the advertisement are encrypted.

In one embodiment, the schedule-related information intended for other controllers around is shared unencrypted as part of the NB channel advertisement, and other UWB parameters specific to the controlees of that controller are encrypted.

Accordingly, the embodiments herein disclose a system for offloading the UWB configuration to the NB advertisement in the wireless network. The system includes the plurality of electronic devices, where the first electronic device of the plurality of electronic devices includes a memory, a processor coupled to the memory, a communicator coupled to the memory and the processor, and an advertisement management controller coupled to the memory, the processor, and the communicator. The advertisement management controller is configured to offload the first set of UWB parameters from the plurality of UWB parameters of the UWB configuration by generating the NB advertisement message comprising the first set of UWB parameters.

Conventional methods and systems provide the request-response setup of ranging is specific to the controller and the controlee, by using only request and response messages and the controller cannot convey its schedule to other controllers around. Furthermore, the request-response messages need to be frequently exchanged every time the schedule is changed, with all the configurations as part of request/response messages, this introduces a lot of resource consumption for over-air transmissions.

Unlike the conventional methods and systems, the proposed method shares schedule-related information in the NB channel advertisement to other controllers. The proposed method transmits the NB channel advertisement before the request and response message exchange. Further, the proposed method offloads certain UWB configuration parameters to the NB advertisement message from the request/response message. The proposed method encrypts the NB advertisement message in a directed advertisement that is read only by the second electronic device among the plurality of electronic devices.

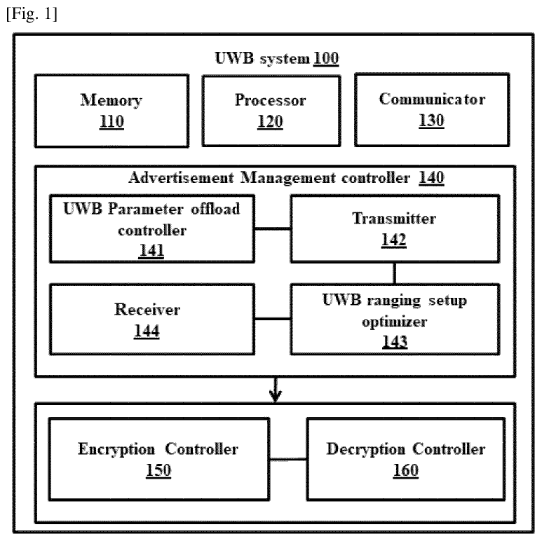

Referring now to the drawings and more particularly to FIGS. 1 through 4, where similar reference characters denote corresponding features consistently throughout the figure, these are shown preferred embodiments.

FIG. 1 is a block diagram of a UWB system (100), according to the embodiments as disclosed herein. The UWB system (100) may be implemented in any electronic device of a plurality of electronic devices in a wireless network. The UWB system (100) includes a memory (110), a processor (120), a communicator (130), an advertisement management controller (140), an encryption controller (150), and a decryption controller (160).

The memory (110) is configured to store instructions to be executed by the processor (120). The memory (110) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) is configured to store larger amounts of information. In certain examples, a nontransitory storage medium may store data that can, over time, change (e.g., in Random Access Memory (RAM) or cache). The non-transitory storage medium may store instructions which, when executed by at least one processor of an electronic device implementing the UWB system (100), cause the electronic device to perform operations of the electronic device described herein.

The processor (120) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (120) may include multiple cores and is configured to execute the instructions stored in the memory (110).

In an embodiment, the communicator (130) includes an electronic circuit specific to a standard that enables wired or wireless communication. The communicator (130) is configured to communicate internally between internal hardware components of the UWB system (100) and with external devices via one or more networks.

In an embodiment, the advertisement management controller (140) includes a UWB parameter offload controller (141), a transmitter (142), a UWB ranging setup optimizer (143), and a receiver (144).

In an embodiment, the UWB parameter offload controller (141) is configured to offload the first set of UWB parameters from the plurality of UWB parameters of the UWB configuration by generating the NB advertisement message (400) comprising the first set of UWB parameters in the NB advertisement such as for example an acquisition packet.

In an embodiment, the transmitter (142) is configured to send the NB advertisement message (400) including the first set of UWB parameters on the NB channel (320) to a second electronic device (310) of the plurality of electronic devices.

In an embodiment, the UWB ranging setup optimizer (143) is configured to generate a request message comprising a second set of UWB parameters from the plurality of UWB parameters of the UWB configuration to optimize a UWB ranging setup in a wireless network.

In an embodiment, the transmitter (142) is configured to send the request message comprising the second set of UWB parameters on the NB channel (320) or the UWB channel (330) to the second electronic device (310).

In an embodiment, the receiver (144) is configured to receive a response message from the second electronic device (310).

The advertisement management controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The advertisement management controller (140) and the processor (120) may be integrally referred to as at least one processor.

At least one of the plurality of modules/components of the advertisement management controller (140) may be implemented through an AI model. A function associated with the AI model may be performed through memory (110) and the processor (120). One or more processors control the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through a calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include but are not limited to, supervised learning, unsupervised learning, semi-supervised learning, or reinforcement learning.

In an embodiment, the encryption controller (150) includes a first electronic device (300) is configured to encrypt a part of the NB advertisement message or a full NB advertisement message specific to the second electronic device (310).

In an embodiment, the decryption controller (160) includes the first electronic device (300) is configured to decrypt a part of the advertisement message not specific to the second electronic device (310).

Although FIG. 1 shows the hardware elements of the UWB system (100) but it is to be understood that other embodiments are not limited thereon. In other embodiments, the UWB system (100) may include one or more number of elements. Further, the labels or names of the elements are used only for illustrative purpose and does not limit the scope of the invention. One or more components can be combined together to perform same or substantially similar function.

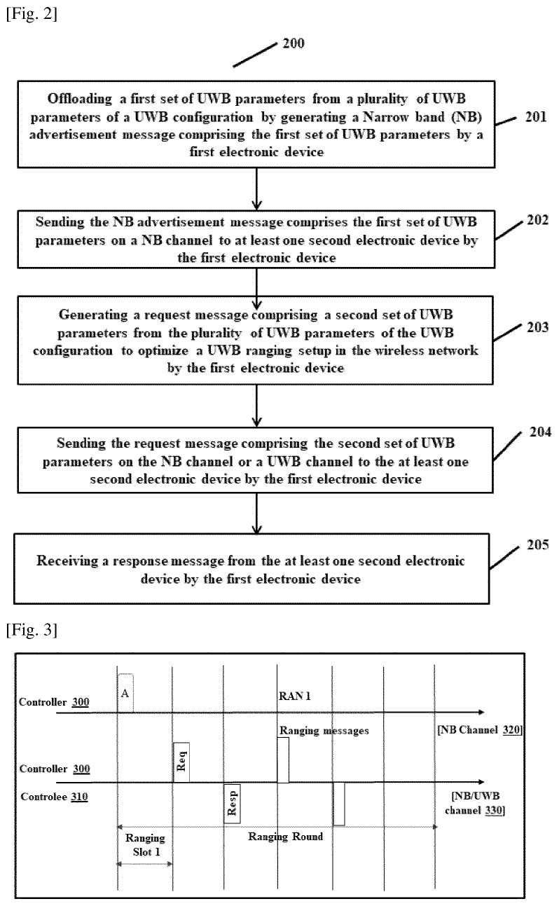

FIG. 2 is a flow diagram illustrating a method (200) for offloading UWB configuration to the NB advertisement in the wireless network, according to the embodiments as disclosed herein.

At step 201, the method includes the first electronic device (300) offloading the first set of UWB parameters from the plurality of UWB parameters of the UWB configuration by generating the NB advertisement message comprising the first set of UWB parameters. The first set of UWB parameters comprises the ranging block structure, the schedule related information, the LBT, hopping parameters, the block size, the round size, the slot size, the current index, the round hopping activation information, the NB hopping information and the NB channel configuration information comprising the NB channel number.

At step 202, the method includes the first electronic device (300) sending the NB advertisement message (400) comprises the first set of UWB parameters on the NB channel (330) to the second electronic device (310).

At step 203, the method includes the first electronic device (300) generating the request message comprising the second set of UWB parameters from the plurality of UWB parameters of the UWB configuration to optimize the UWB ranging setup in the wireless network. The second set of UWB parameters comprises the ranging round usage information, the scheduled mode, the deferred mode, and the mini slot.

At step 204, the method includes the first electronic device (300) sending the request message comprising the second set of UWB parameters on the NB channel (330) or the UWB channel (340) to the second electronic device (310).

In an embodiment, upon receiving the request message comprising the second set of UWB parameters on the NB channel (330) or the UWB channel (340) from the first electronic device (300) by the second electronic device (310).

In an embodiment, the second electronic device (310) determines the PHY parameters and roles associated with the first electronic device (300).

In an embodiment, the second electronic device (310) establishes the UWB ranging session with the first electronic device (300) based on the PHY parameters and the roles associated with the first electronic device (300).

At step 205, the method includes the first electronic device (300) receiving the response message from the second electronic device (310).

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

FIG. 3 is an example illustrating usage of the NB advertisement along with a request/response message, according to an embodiment as disclosed herein. Furthermore, FIG. 3 illustrates an advertisement in the NB channel before the request and response message exchange.

The NB advertisement is transmitted before the request and response message exchange.

Configurations apart from those shared in the advertisement are transmitted using the request/response message exchange.

The first electronic device (300) sends the advertisement conveying the ranging block structure, the schedule, the LBT, and the hopping parameters. In an embodiment, the parameters in the NB advertisement are the block size, the round size, the slot size, the current index, the round hopping activation, the NB channel hopping details, and an accompanying NB channel configuration including the NB channel number.

The request/response message is used only to set up ranging sessions PHY parameters, device roles and the like.

In an embodiment, the parameters in the request/response message are included but not limited to the ranging round usage, the scheduled mode, the deferred mode, and the mini slot.

In an embodiment, the second electronic device (310) of the plurality of electronic devices is configured to receive the request message comprising the second set of UWB parameters on the NB channel (320) or the UWB channel (330) from the first electronic device (300).

In an embodiment, the second electronic device (310) of the plurality of electronic devices is configured to determine PHY parameters and roles associated with the first electronic device (300).

In an embodiment, the second electronic device (310) of the plurality of electronic devices is configured to establish a UWB ranging session with the first electronic device (300) based on the PHY parameters and the roles associated with the first electronic device (300).

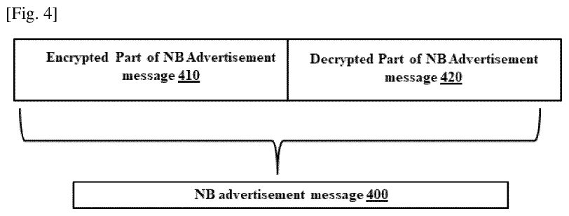

FIG. 4 illustrates a NB advertisement message (400), according to an embodiment as disclosed herein. The NB advertisement message (400) includes an encrypted part of the NB advertisement message (410) and a decrypted part of the NB advertisement message (420).

Referring to FIG. 1, the schedule-related information is sent as a part of the advertisement in the NB. The first electronic device (300) is configured to define the encrypted or decrypted NB advertisement message. Also, some part of the advertisement is decrypted and some part of the advertisement is encrypted.

In an embodiment, the first electronic device (300) is configured to encrypt a part of the NB advertisement message or a full advertisement message specific to the second electronic device (310).

In an embodiment, the encrypted part of the NB advertisement message (410) is read only by the second electronic device (310) among the plurality of electronic devices.

In an embodiment, the first electronic device (300) is configured to decrypt a part of the NB advertisement message not specific to the second electronic device (310).

In an embodiment, a decrypted part of the NB advertisement message in the directed advertisement is open and intended for all the plurality of electronic devices.

The embodiments disclosed herein can be implemented using one hardware device and performing network management functions to control the elements.

The various actions, acts, blocks, steps, or the like in the method may be performed in the order presented, in a different order, or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method for offloading an ultra-wideband (UWB) configuration to a narrowband (NB) advertisement by a first electronic device in a wireless network, the method comprising:
generating an NB advertisement for assisting UWB communication, the NB advertisement including a first set of UWB parameters from a plurality of UWB parameters of a UWB configuration; and
sending the NB advertisement including the first set of UWB parameters on an NB channel to at least one second electronic device.

17. The method of claim 16, wherein the first set of UWB parameters includes at least one of a ranging block structure, schedule related information to schedule UWB transmission between a plurality of electronic devices, a listen before talk (LBT) parameter, hopping parameters, a block size, a round size, a slot size, a current index, a round hopping activation information, NB hopping information, or NB channel configuration information including an NB channel number.

18. The method of claim 16, further comprising:
generating a request including a second set of UWB parameters from the plurality of UWB parameters of the UWB configuration to optimize a UWB ranging setup in the wireless network;
sending the request including the second set of UWB parameters on the NB channel or a UWB channel to the at least one second electronic device; and
receiving a response from the at least one second electronic device,
wherein the second set of UWB parameters includes at least one of ranging round usage information, a scheduled mode, a deferred mode, or a mini slot.

19. The method of claim 17, wherein PHY parameters and roles associated with the first electronic device are determined by the at least one second electronic device based on receiving the request including the second set of UWB parameters, and
wherein a UWB ranging session with the first electronic device is established by the at least one second electronic device based on the PHY parameters and the roles associated with the first electronic device.

20. The method of claim 16, further comprising:
encrypting a part of the NB advertisement or a full advertisement specific to the at least one second electronic device; and
decrypting a part of the advertisement not specific to the at least one second electronic device.

21. The method of claim 20, wherein an encrypted part of the NB advertisement in a directed advertisement is read only by the at least one second electronic device among a plurality of electronic devices in the wireless network.

22. The method of claim 20, wherein a decrypted part of the NB advertisement in a directed advertisement is open and intended for all electronic devices in the wireless network.

23. A first electronic device for offloading ultra-wideband (UWB) configuration to a narrowband (NB) advertisement in a wireless network, the first electronic device comprising:
a memory;
a communicator; and
at least one processor coupled to the memory and the communicator, wherein the at least one processor is configured to:
generate an NB advertisement for assisting UWB communication, the NB advertisement including a first set of UWB parameters from a plurality of UWB parameters of a UWB configuration, and
send the NB advertisement including the first set of UWB parameters on an NB channel to at least one second electronic device.

24. The first electronic device of claim 23, wherein the first set of UWB parameters includes at least one of a ranging block structure, schedule-related information to schedule UWB transmission, a listen before talk (LBT) parameter, hopping parameters, a block size, a round size, a slot size, a current index, round hopping activation information, NB hopping information, or NB channel configuration information including an NB channel number.

25. The first electronic device of claim 23, wherein the at least one processor is configured to:
generate a request including a second set of UWB parameters from the plurality of UWB parameters of the UWB configuration to optimize a UWB ranging setup in the wireless network,
send the request including the second set of UWB parameters on the NB channel or a UWB channel to the at least one second electronic device, and
receive a response from the at least one second electronic device,
wherein the second set of UWB parameters includes at least one of ranging round usage information, a scheduled mode, a deferred mode, or a mini slot.

26. The first electronic device of claim 25, wherein PHY parameters and roles associated with the first electronic device are determined by the at least one second electronic device based on receiving the request including the second set of UWB parameters, and
wherein a UWB ranging session with the first electronic device is established by the at least one second electronic device based on the PHY parameters and the roles associated with the first electronic device.

27. The first electronic device of claim 23, wherein the at least one processor is configured to:
encrypt a part of the NB advertisement or a full advertisement specific to the at least one second electronic device, and
decrypt a part of the advertisement not specific to the at least one second electronic device.

28. The first electronic device of claim 27, wherein an encrypted part of an NB advertisement in a directed advertisement is read only by the at least one second electronic device among a plurality of electronic devices in the wireless network.

29. The first electronic device of claim 27, wherein a decrypted part of an NB advertisement in a directed advertisement is open and intended for all electronic devices in the wireless network.

30. A non-transitory computer readable storage medium storing instructions which, when executed by at least one processor of a first electronic device in a wireless network, cause the first electronic device to perform operations, the operations comprising:
generating a narrowband (NB) advertisement for assisting ultra-wideband (UWB) communication, the NB advertisement including a first set of UWB parameters from a plurality of UWB parameters of a UWB configuration; and
sending the NB advertisement including the first set of UWB parameters on an NB channel to at least one second electronic device.

31. The non-transitory computer readable storage medium of claim 30, wherein the first set of UWB parameters includes at least one of a ranging block structure, schedule related information to schedule UWB transmission between a plurality of electronic devices, a listen before talk (LBT) parameter, hopping parameters, a block size, a round size, a slot size, a current index, round hopping activation information, NB hopping information, or NB channel configuration information including an NB channel number.

32. The non-transitory computer readable storage medium of claim 30, wherein the operations further comprise:
generating a request including a second set of UWB parameters from the plurality of UWB parameters of the UWB configuration to optimize a UWB ranging setup in the wireless network;
sending the request including the second set of UWB parameters on the NB channel or a UWB channel to the at least one second electronic device; and
receiving a response from the at least one second electronic device,
wherein the second set of UWB parameters includes at least one of ranging round usage information, a scheduled mode, a deferred mode, or a mini slot.

33. The non-transitory computer readable storage medium of claim 32, wherein PHY parameters and roles associated with the first electronic device are determined by the at least one second electronic device based on receiving the request including the second set of UWB parameters, and
wherein a UWB ranging session with the first electronic device is established by the at least one second electronic device based on the PHY parameters and the roles associated with the first electronic device.

34. The non-transitory computer readable storage medium of claim 30, wherein the operations further comprise:
encrypting a part of the NB advertisement or a full advertisement specific to the at least one second electronic device; and
decrypting a part of the advertisement not specific to the at least one second electronic device.

35. The non-transitory computer readable storage medium of claim 34, wherein an encrypted part of an NB advertisement in a directed advertisement is read only by the at least one second electronic device among a plurality of electronic devices in the wireless network.
